(19) United States
(12) Patent Application Publication
(10) Pub. No.: US 2011/0234170 A1
(43) Pub. Date: Sep. 29, 2011

(54) CIRCUITS, SYSTEMS AND METHODS FOR BALANCING BATTERY CELLS

(75) Inventor: Wei ZHANG, Shanghai (CN)

(73) Assignee: O2MICRO, INC., Santa Clara, CA (US)

(21) Appl. No.: 13/089,051

(22) Filed: Apr. 18, 2011

(30) Foreign Application Priority Data
Mar. 30, 2011 (CN) 201110083519.7

(51) Int. Cl. H02J 7/00

(52) U.S. Cl. 320/134

(57) ABSTRACT

A circuit for balancing a plurality of battery cells includes a controller and an electronic control unit (ECU) coupled to the controller. The controller samples multiple discharging cell voltages of the battery cells respectively at a predetermined time during a discharging state of the battery cells, and samples multiple charging cell voltages of the battery cells respectively during a charging state of the battery cells. The ECU processes the charging cell voltages and the discharging cell voltages, thereby providing control commands for the controller to control the battery cells to achieve a balance.

### CROSS REFERENCE TO RELATED APPLICATION

This application claims priority to Patent Application Number 201110083519.7, filed on Mar. 30, 2011 with the State Intellectual Property Office of the P.R. China (SIPO), which is hereby incorporated by reference.

### BACKGROUND

The demand for electronic devices and systems has been expanding, which results in a fast development of batteries, e.g., rechargeable batteries. There are various types of batteries, such as Lithium-Ion battery and Lead-Acid battery. A battery can include multiple battery cells. Charging and discharging the battery through normal operation over time may result in cell-to-cell variations in cell voltages. When one or more battery cells in a series string charge faster or slower than the others, an unbalanced condition may occur. If there is unbalance between any two of the battery cells in the battery aging process of the battery is accelerated, and therefore the lifetime of the battery is shortened.

A conventional solution of balancing battery cells is based upon charging cell voltages, as a higher charging cell voltage of a battery cell generally indicates a higher battery cell capacity. A charging cell voltage herein refers to a cell voltage of a battery cell in a charging state. For example, when a charging cell voltage V1 of a battery cell in a battery is greater than a first threshold voltage Vth1, the battery cell is determined as an unbalanced battery cell. Alternatively, for example, if a cell voltage difference ΔV between a battery cell having the maximum charging cell voltage VH and a battery cell having the minimum charging cell voltage VL in a battery is greater than a second threshold voltage Vth2, the battery cell having the maximum charging cell voltage VH is determined as an unbalanced battery cell. As one or more unbalanced battery cells are identified, a balancing circuit performs a balancing operation on these unbalanced battery cells.

However, as the battery cells age over a time period, a higher charging cell voltage of a battery cell does not necessarily indicates a higher battery cell capacity. As such, such conventional solution is problematic when applied to the battery with aged battery cells.

### SUMMARY

In one embodiment, a circuit for balancing a plurality of battery cells includes a controller and an electronic control unit (ECU) coupled to the controller. The controller samples multiple discharging cell voltages of the battery cells respectively at a predetermined time during a discharging state of the battery cells and samples a plurality of charging cell voltages of the battery cells respectively in a charging state of the battery cells. The ECU processes the charging cell voltages and the discharging cell voltages, thereby providing control commands for the controller to control the battery cells to achieve a balance.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates a system for balancing battery cells according to one embodiment of the present invention.

FIG. 2 illustrates a circuit for balancing battery cells according to one embodiment of the present invention.

FIG. 3(a) is a column diagram illustrating a relationship between a discharging cell voltage and a cell capacity of a battery cell in a discharging state according to one embodiment of the present invention.

FIG. 3(b) is a column diagram illustrating a relationship between a charging cell voltage and a cell capacity of a battery cell in a charging state according to one embodiment of the present invention.

FIG. 4 illustrates a system for balancing battery cells according to another embodiment of the present invention.

FIG. 5 is a flowchart of a method for balancing battery cells according to one embodiment of the present invention.

FIG. 6 illustrates an electric vehicle having a system for balancing battery cells according to one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “processing,” “calculating,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments in accordance with the present invention provide circuits, systems and methods for balancing battery cells. In one embodiment, a circuit for balancing battery cells includes a controller and an electronic control unit (ECU) coupled to the controller. The controller samples multiple discharging cell voltages of the battery cells respectively at a predetermined time during a discharging state of the battery cells, and samples multiple charging cell voltages of the battery cells respectively during a charging state of the battery cells. The ECU processes the charging cell voltages and the discharging cell voltages, thereby providing control commands for the controller to control the battery cells to achieve a balance.

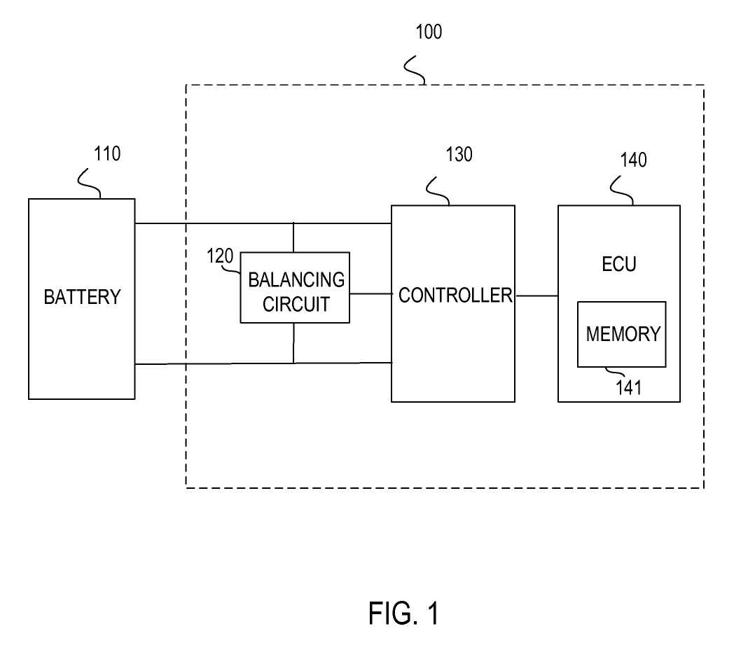

FIG. 1 illustrates a system 100 for balancing battery cells according to one embodiment of the present invention. In the example of FIG. 1, the system 100 is coupled to a battery 110. The battery 100 can be, but is not limited to, a Lithium-Ion battery or Lead-Acid battery. In one embodiment, the system 100 includes a balancing circuit 120 coupled to the battery 110, a controller 130 coupled to the balancing circuit 120 and the battery 110, and an ECU 140 coupled to the controller 130. In one embodiment, the ECU 140 further includes a memory 141. In one embodiment, the controller 130, the ECU 140 and the memory 141 are integrated together in an integrated circuit (IC).

The controller 130 monitors the battery cells in the battery 110 to obtain measurement information of the battery cells, and further provides the measurement information to the ECU 140. In one embodiment, the measurement information includes, but is not limited to, cell voltages of the battery cells and temperatures of the battery cells. For example, the controller 130 samples a plurality of cell voltages of the battery cells respectively at a predetermined time T during a discharging state of the battery cells (referred to as “discharging cell voltages”), and samples a plurality of cell voltages of the battery cells respectively during a charging state of the battery 110 (referred to as “charging cell voltages”). The ECU 140 processes the charging cell voltages and the discharging cell voltages, thereby providing control commands for the controller 130 to control the battery cells in the battery 110 to achieve cell balancing.

More specifically, the controller 130 samples the discharging cell voltage of each battery cell at a predetermined time T during the discharging state of the battery cells. In one embodiment, the predetermined time T corresponds to the end of the discharging state or near the end of the discharging state. Once the discharging state ends, the battery cells can be charged immediately or after an idle state. The sampled discharging cell voltages of the battery cells are sent to the ECU 140 and further stored into the memory 141. During the charging state, the controller 130 samples the charging cell voltages of the battery cells through one or more sampling cycles of the charging state and sends the sampled charging cell voltages to the ECU 140. In each sampling cycle, the ECU 140 identifies any unbalanced battery cell according to the discharging cell voltages stored in the memory 141 and the sampled charging cell voltages of the sampling cycle, and provides the control commands accompanied with identification information of the unbalanced battery cells to the controller 130, in one embodiment. Accordingly, the controller 130 controls the balancing circuit 120 to perform a balancing operation on the unbalanced battery cells. The balancing circuit 120 enables a balancing current (bypass current) for a respective battery cell if the battery cell is unbalanced. In one embodiment, the ECU 140 further provides the control commands to control a pre-balancing operation on the battery cells based upon the discharging cell voltages stored in the memory 141 to achieve the balance more efficiently.

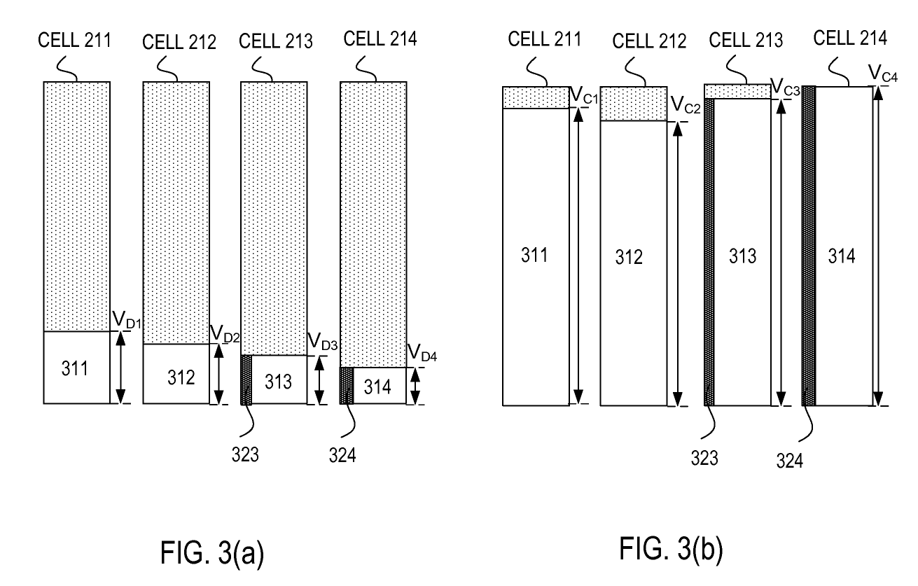

By detecting the unbalanced battery cells based upon both the charging cell voltages and the discharging cell voltages, the system 100 detects the unbalanced battery cells in a more reliable way, which is further described in relation to FIGS. 3(a) and 3(b). Moreover, by performing the pre-balancing operation during the charging state, the system 100 achieves the balance more efficiently. As a result of the improved performance of the system 100, the lifetime of the battery 110 is prolonged.

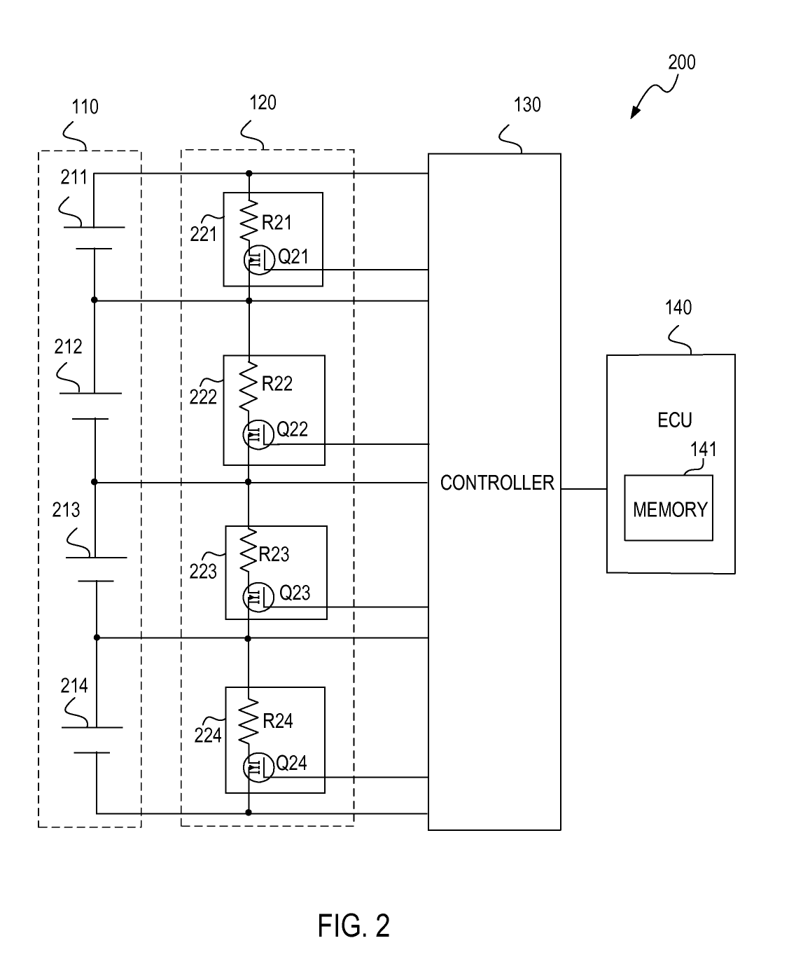

FIG. 2 illustrates a circuit 200 for balancing battery cells according to one embodiment of the present invention. Elements labeled the same as in FIG. 1 have similar functions. In the example of FIG. 2, the battery 110 includes battery cells 211-214 coupled in series. The battery cells 211-214 are coupled to balancing units 221-224 of the balancing circuit 120, respectively. Each of the balancing units 221-224 includes a resistor and a switch, in the example of FIG. 2. For example, the balancing units 221-224 includes series-coupled resistor R21 and switch Q21, resistor R22 and switch Q22, resistor R23 and switch Q23, and resistor R24 and switch Q24, respectively.

As discussed in relation to FIG. 1, if the battery 110 is undergoing an unbalanced condition, the controller 130 receives the control commands and identification information of the unbalanced battery cells from the ECU 140. For example, if the battery cell 211 is detected as an unbalanced battery cell, the controller 130 switches on the switch Q21 to enable a balancing current flowing through the balancing unit 221. The switch Q21 remains on to enable the balancing current until the battery cell 211 is determined as a balanced battery cell by the ECU 140, in one embodiment. That is, the switch Q21 is switched off when the battery cell 211 gets back to a balanced condition as a result of the balancing operation of the balancing unit 221. In one embodiment, the balancing current can be predetermined.

FIG. 3(a) shows a column diagram illustrating a relationship between a discharging cell voltage and a cell capacity of a battery cell in a discharging state according to one embodiment of the present invention. For example, areas of transparent blocks 311-314 represent the cell capacities of the battery cells 211-214, respectively. A height of a transparent block represents the discharging cell voltage of a corresponding battery cell at the predetermined time T of the discharging state. As illustrated by FIG. 3(a), the discharging cell voltages of the battery cells 211-214 at the predetermined time T are V_{D1}, V_{D2}, V_{D3}, and V_{D4}, respectively, where a sequence of V_{D1}, V_{D2}, V_{D3}, and V_{D4} from the minimum to the maximum is V_{D4}<V_{D3}<V_{D2}<V_{D1}. An area of an opaque block 323 represents internal impedance associated with part of the battery cell 213 that accommodates the cell capacity illustrated by transparent block 313. Similarly, an area of an opaque block 324 represents internal impedance associated with part of the battery cell 214 that accommodates the cell capacity illustrated by transparent block 314. The internal impedance of a battery cell increases with the age of the battery cell. Due to different aging speeds and/or different cell characteristics, the internal impedance may differ for different battery cells. For example, the internal impedance of the battery cells 211 and 212 is less and ignorable.

FIG. 3(b) shows a column diagram illustrating a relationship between a charging cell voltage and a cell capacity of a battery cell in a charging state according to one embodiment of the present invention. In one embodiment, the charging cell voltages of the battery cells are sampled periodically. As an example, FIG. 3(b) shows the charging cell voltages sampled when the battery cells are fully charged or nearly fully charged. As shown in FIG. 3(b), the charging cell voltages of the battery cells 211-214 in the sample cycle are V_{C1}, V_{C1}, V_{C1}, and V_{C4}, respectively, where a sequence of V_{C1}, V_{C1}, V_{C1}, and V_{C4} from the minimum to the maximum is V_{C2}<V_{C1}<V_{C3}<V_{C4}. As shown in FIG. 3(b), although the battery cell 214 has the maximum cell voltage V_{C4}, the cell capacity of the battery cell 214 is not the maximum due to its internal impedance shown as the opaque block 324. Therefore, it is more accurate by using the discharging cell voltages and the charging cell voltages in identifying unbalanced battery cells in each sampling cycle of the charging state.

Referring back to FIG. 1, the controller 130 samples the discharging cell voltages at the predetermined time T during the discharging state. The ECU 140 receives the discharging cell voltages and stores the discharging cell voltages in the memory 141. In one embodiment, the ECU 140 further sorts out the discharging cell voltages according to voltage levels of the discharging cell voltages, e.g., from the minimum to the maximum. The controller 130 also samples the charging cell voltages periodically during the charging state. The ECU 140 receives the charging cell voltages of each sampling cycle and stores the charging cell voltages in the memory 141. In one embodiment, the ECU 140 further sorts out the charging cell voltages according to voltage levels of the charging cell voltages, e.g., from the minimum to the maximum, in each sampling cycle.

For each sampling cycle, an unbalanced battery cell is identified based upon the discharging cell voltages at the predetermined time T and the charging cell voltages sampled in a corresponding sampling cycle. More specifically, the ECU 140 selects a reference battery cell from the battery cells. In one embodiment, a battery cell having the minimum charging cell voltage compared to other battery cells is selected as the reference battery cell. Accordingly, a battery cell having a discharging cell voltage greater than the discharging cell voltage of the reference battery cell is determined as an unbalanced battery cell, in one embodiment. Alternatively, the ECU 140 determines the sequence of the charging cell voltages and the discharging cell voltages, and identifies any unbalanced battery cell based upon the determined sequences.

For example, according to the charging cell voltages V_{C1}−V_{C4} illustrated by FIG. 3(b), the battery cell 212 which has the minimum charging cell voltage V_{C2} is selected as the reference battery cell. The discharging cell voltage V_{D1} of the battery cell 211 illustrated by FIG. 3(a) is greater than the discharging cell voltage V_{D2} of the reference battery cell (e.g., battery cell 212), and thus the battery cell 211 is determined as an unbalanced battery cell. The ECU 140 then provides a control command for the controller 130 to control a corresponding balancing unit to enable a balancing current for the unbalanced battery cell.

Advantageously, by relying upon both the charging cell voltages and the discharging cell voltages, the system 100 detects the unbalanced battery cells in a more reliable way.

Furthermore, the system 100 can perform a pre-balancing operation on the battery 110 when a charging of the battery cells is initiated following a previous discharging state. In one embodiment, the ECU 140 calculates differential capacities of the battery cells respectively and enables a pre-balancing operation according to the differential capacities of the battery cells. The differential capacities of the battery cells are determined based upon the discharging cell voltages at the predetermined time T of the previous discharging state. In another embodiment, the ECU 140 further calculates pre-balancing time periods for the battery cells based upon the corresponding differential capacities of the battery cells and a balancing current.

More specifically, in one embodiment, the ECU 140 calculates cell voltage differences between the battery cell having the minimum discharging cell voltage and any other battery cell. Based upon the cell voltage differences, the ECU 140 determines a differential capacity for a corresponding battery cell, i.e., a capacity difference between the corresponding battery cell and the battery cell having the minimum discharging cell voltage. Table 1 shows an example of the differential capacity of a battery cell.

TABLE 1
Differential Capacity

| Minimum | | | | |
|---|---|---|---|---|
| Discharging | Cell Voltage Difference | | | |
| Cell Voltage | 20~40 mV | 40~60 mV | 60~80 mV | ≧80 mV |
| 1.75 V~1.8 V | 0.1 Ah | 0.2 Ah | 0.4 Ah | 0.6 Ah |
| 1.8 V~1.85 V | 0.2 Ah | 0.4 Ah | 0.6 Ah | 0.6 Ah |
| ≧1.85 V | 0.4 Ah | 0.6 Ah | 0.6 Ah | 0.6 Ah |

As illustrated by Table 1, the differential capacities are affected by the cell voltage differences and voltage levels of the minimum discharging cell voltages. For example, when the minimum discharging cell voltage is 1.76V, a battery cell which has a discharging cell voltage greater than the minimum discharging cell voltage by 30 mV has a differential capacity of approximately 0.1 Ah, and a battery cell which has a discharging cell voltage greater than the minimum discharging cell voltage by 70 mV has a differential capacity of approximately 0.4 Ah. In another example where the minimum discharging cell voltage is 1.81V, a battery cell having a discharging cell voltage greater than the minimum discharging cell voltage by 30 mV has a differential capacity of approximately 0.2 Ah, and a battery cell having a discharging cell voltage greater than the minimum discharging cell voltage by 70 mV has a differential capacity of approximately 0.6 Ah. As shown in the example of Table 1, the differential capacities range from 0 Ah and 0.6 Ah, and the battery cells of which the discharging cell voltages exceed the minimum discharging cell voltage by less than 20 mV has a differential capacity of approximately 0 Ah.

Based upon the minimum discharging cell voltage and the cell voltage differences, the ECU 140 looks up the differential capacities of the corresponding battery cells from table 1. When the battery 110 switches from the discharging state to the charging state, the controller 130 controls the balancing circuit 120 to perform the pre-balancing operation on the battery cells. More specifically, for the pre-balancing operation, a switch in a balancing unit coupled to a corresponding battery cell is switched on to enable the balancing current, thereby releasing the differential capacity of the battery cell.

In one embodiment, pre-balancing time periods for the battery cells are calculated by the ECU 140 based upon the corresponding differential capacities and the balancing current. Assuming that the balancing current is predetermined to be 150 mA, Table 2 shows an example of the corresponding pre-balancing time periods for the battery cells.

TABLE 2
Pre-balancing Time Period

| Minimum | | | | | | |
|---|---|---|---|---|---|---|
| Discharging Cell | Cell Voltage Difference | | | | | |
| Voltage | 20~40 mV | 40~60 mV | | 60~80 mV | | ≧80 mV |
| 1.75 V~1.8 V | 0.5~0.6 hrs | 1.0~1.2 | hrs | 2.0~2.4 | hrs | 3 hrs |
| 1.8 V~1.85 V | 1.0~1.2 hrs | 2.0~2.4 | hrs | 3 | hrs | 3 hrs |
| ≧1.85 V | 2.0~2.4 hrs | 3 | hrs | 3 | hrs | 3 hrs |

According to Table 2, when the minimum discharging cell voltage is 1.76V, the pre-balancing operation for the battery cell which has a 30 mV cell voltage difference from the minimum cell discharging cell voltage lasts for approximately 0.5˜0.6 hour, and the pre-balancing operation for the battery cell which has a 70 mV cell voltage difference from the minimum cell discharging cell voltage lasts for approximately 2.0˜2.4 hours. In another circumstance where the minimum discharging cell voltage is 1.81V, the pre-balancing operation for the battery cell which has a 30 mV cell voltage difference from the minimum discharging cell voltage lasts for approximately 1.0˜1.2 hours, and the pre-balancing operation for the battery cell which has a 70 mV cell voltage difference from the minimum discharging cell voltage lasts for approximately 3 hours.

In one embodiment, Table 1 is stored in the memory 141 as a pre-balancing table, and the pre-balancing time periods for the battery cells are further determined according to the differential capacities and the balancing current. In another embodiment, Table 2 is stored in the memory 141 as a pre-balancing table, and thus pre-balancing is enabled for the pre-balancing time periods shown in Table 2.

Due to the pre-balancing operation, the differential capacities of the battery cells carried over from the discharging state to the charging state are reduced or eliminated. As such, the balancing operation of the battery management system 100 is performed more efficiently.

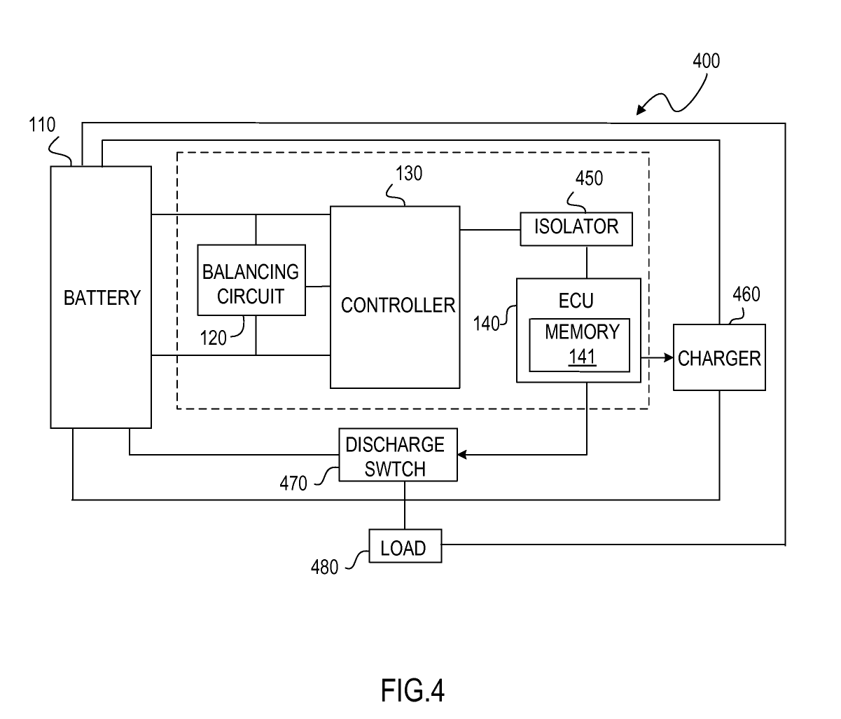

FIG. 4 illustrates a block diagram of a system 400 for balancing a battery according to another embodiment of the present invention. Elements labeled the same as in FIGS. 1 and 2 have similar functions. The system 400 further includes an isolator 450 and a discharge switch 470. The isolator 450 is coupled between the controller 130 and the ECU 140. The controller 130 is electrically isolated from the ECU 140 by the isolator 450. The discharge switch 470 is coupled to the battery 110, and a load 480 is coupled between the discharge switch 470 and the battery 110. The discharge switch 470 controls discharging of the battery 110 under control of the ECU 140. In one embodiment, the discharge switch 470 comprises a metal-oxide-semiconductor-field-effect-transistor (MOSFET). In one embodiment, a charger 460 is coupled to the battery 110. The charger 460 charges the battery 110 under control of the ECU 140.

As discussed in relation to FIG. 1, the ECU 140 obtains the voltage and/or temperature information from the controller 130. Based upon the voltage and/or temperature information, the ECU 140 determines whether the battery 110 is undergoing an abnormal condition, e.g., over-voltage condition, under-voltage condition, over-temperature condition, and unbalanced condition. In response to detection of these abnormal conditions, the ECU 140 performs protective actions. For example, if the temperature rises too fast during charging, discharging or balancing, the system 400 cuts off the circuits associated with the charging, discharging or balancing to prevent the battery 110 from being damaged.

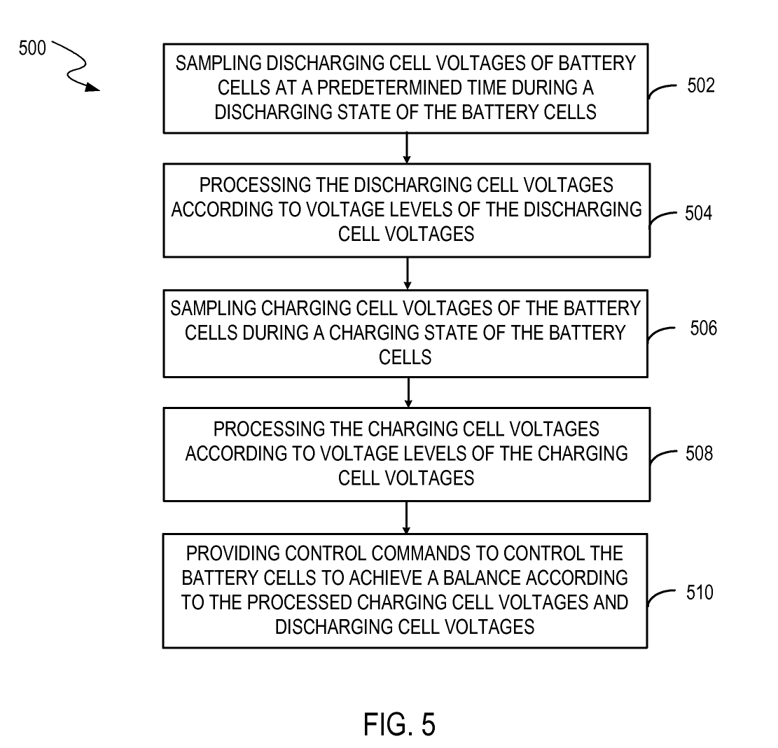

FIG. 5 illustrates a flowchart 500 of a method for balancing a battery including a plurality of battery cells according to one embodiment of the present invention. In one embodiment, the system 100 operates in accordance with the flowchart 500 to balance the battery 110 including battery cells 211-214. FIG. 5 is described in combination with FIG. 1 and FIG. 2. Although specific steps are disclosed in FIG. 5, such steps are examples. That is, the present invention is well suited to performing various other steps or variations of the steps recited in FIG. 5.

In block 502, a controller samples discharging cell voltages of battery cells respectively at a predetermined time during a discharging state of the battery cells. In one embodiment, the controller 130 samples the discharging cell voltages V_{D1}−V_{D4} of the battery cells 211-214 respectively at the predetermined time T during the discharging state of the battery cells 211-214. In one embodiment, the predetermined time T corresponds to the end of the time the discharging state or near the end of the discharging state.

In block 504, a processor or control unit, e.g., an ECU processes the discharging cell voltages of the battery cells according to voltage levels of the discharging cell voltages. In one embodiment, the ECU 140 receives the discharging cell voltages V_{D1}−V_{D4} of the battery cells 211-214 from the controller 130, and processes the discharging cell voltages V_{D1}−V_{D4} according to the voltage levels of the discharging cell voltages V_{D1}−V_{D4}, e.g., from the minimum to the maximum, where V_{D4}<V_{D3}<V_{D2}<V_{D1}.

In block 506, the controller samples charging cell voltages of the battery cells respectively during a charging state of the battery cells. In one embodiment, the charging cell voltages are sampled periodically in different sampling cycles. In each sampling cycle during the charging state, the controller 130 samples the charging cell voltages V_{C1}−V_{C4} of the battery cells 211-214.

In block 508, the ECU processes the charging cell voltages of the battery cells according to voltage levels of the charging cell voltages. In one embodiment, the ECU 140 receives the charging cell voltages V_{C1}−V_{C4} of the battery cells 211-214 from the controller 130, and processes the charging cell voltages V_{C1}−V_{C4} according to the voltage levels of the charging cell voltages V_{C1}−V_{C4}, e.g., from the minimum to the maximum, where V_{C2}<V_{C1}<V_{C3}<V_{C4}.

In block 510, the ECU provides control commands for the controller to control the battery cells to achieve cell balancing according to the processed discharging cell voltages and the charging cell voltages. In one embodiment, the ECU 140 provides the control commands for the controller 130 to control a balance operation on the battery cells 211-214 based upon the discharging cell voltages V_{D1}−V_{D4} and the charging cell voltages V_{C1}−V_{C4}. In another embodiment, the ECU 140 provides the control commands for the controller 130 to control a pre-balancing operation on the battery cells 211-214 based upon the discharging cell voltages V_{D1}−V_{D4} when the charging of the battery cells 211-214 is initiated from the previous discharging state.

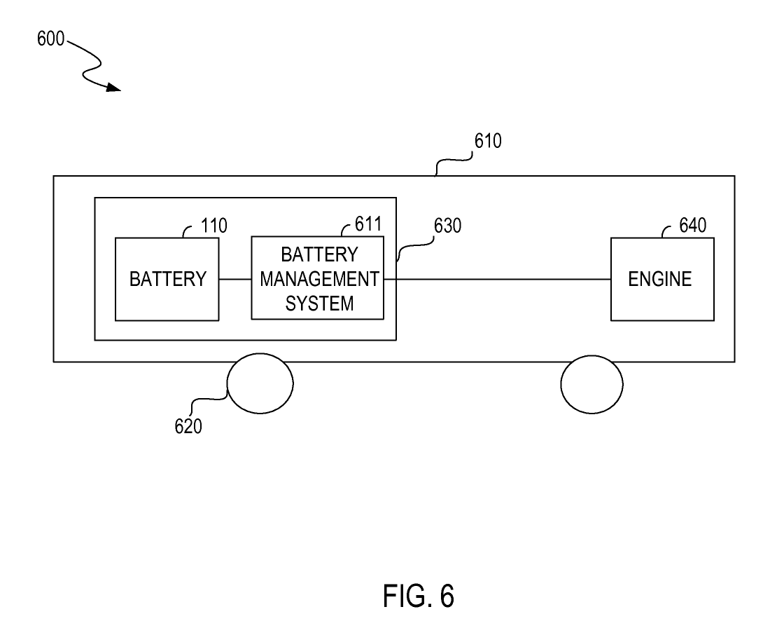

FIG. 6 illustrates an electric vehicle or a hybrid electric vehicle 600 according to one embodiment of the present invention. Elements labeled the same as in FIG. 1 have similar functions. In one embodiment, the electric vehicle 600 includes a vehicle body 610, multiple wheels 620, a battery system 630, and an engine 640. The vehicle body 610 accommodates the battery system 630 and the engine 640. The battery system 630 includes the battery 110 and a battery management system 611. In one embodiment, the battery management system 611 can employ the system 100 illustrated in FIG. 1 or the circuit 200 illustrated in FIG. 2. The battery system 630 provides electric power to the engine 640, and the engine 640 coupled to the battery system 630 further converts the electric power to motion energy to propel the wheels, such that the electric vehicle 600 moves.

While the foregoing description and drawings represent embodiments of the present invention, it will be understood that various additions, modifications and substitutions may be made therein without departing from the spirit and scope of the principles of the present invention. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, and not limited to the foregoing description.

What is claimed is:

1. A circuit for balancing a plurality of battery cells, said circuit comprising:
a controller coupled to said battery cells and operable for sampling a plurality of discharging cell voltages of said battery cells respectively at a predetermined time during a discharging state of said battery cells and for sampling a plurality of charging cell voltages of said battery cells respectively during a charging state of said battery cells; and
an electronic control unit (ECU) coupled to said controller and operable for processing said charging cell voltages and said discharging cell voltages, thereby providing control commands for said controller to control said battery cells to achieve a balance.

2. The circuit of claim 1, wherein said predetermined time corresponds to end of said discharging state.

3. The circuit of claim 1, further comprising:
a balancing circuit coupled to said battery cells and said controller, and operable for enabling a balancing current for a respective battery cell.

4. The circuit of claim 1, wherein said ECU generates said control commands to perform a balancing operation on an unbalanced battery cell which is identified based upon said charging cell voltages and said discharging cell voltages.

5. The circuit of claim 4, wherein a discharging cell voltage of said unbalanced battery cell is higher than a discharging cell voltage of a reference battery cell, and wherein said reference battery cell is selected from said battery cells based upon said charging cell voltages.

6. The circuit of claim 4, wherein said unbalanced battery cell is identified based upon a sequence of said charging cell voltages and a sequence of said discharging cell voltages.

7. The circuit of claim 1, wherein said ECU generates said control commands to perform a pre-balancing operation on said battery cells when said charging state is initiated, and wherein pre-balancing time periods for said battery cells are determined based upon said discharging cell voltages.

8. The circuit of claim 7, further comprising:
a memory for storing a pre-balancing table used for determining said pre-balancing time periods.

9. A system comprising:
a plurality of battery cells; and
an integrated circuit coupled to said battery cells and operable for sampling a plurality of discharging cell voltages of said battery cells respectively at a predetermined time during a discharging state of said battery cells, and for sampling a plurality of charging cell voltages of said battery cells respectively during a charging state of said battery cells, thereby providing control commands for controlling said battery cells to achieve a balance.

10. The system of claim 9, wherein said predetermined time corresponds to end of said discharging state.

11. The system of claim 9, further comprising:
a balancing circuit coupled to said battery cells and said integrated circuit, and operable for enabling a balancing current for a respective battery cell.

12. The system of claim 9, wherein said integrated circuit generates said control commands to perform a balancing operation on an unbalanced battery cell which is identified based upon said charging cell voltages and said discharging cell voltages.

13. The system of claim 12, wherein a discharging cell voltage of said unbalanced battery cell is higher than a discharging cell voltage of a reference battery cell, and wherein said reference battery cell is selected from said battery cells based upon said charging cell voltages.

14. The system of claim 12, wherein said unbalanced battery cell is identified based upon a sequence of said charging cell voltages and a sequence of said discharging cell voltages.

15. The system of claim 9, wherein said integrated circuit generates said control commands to perform a pre-balancing operation on said battery cells when said charging state is initiated, and wherein pre-balancing time periods for said battery cells are determined based upon said discharging cell voltages.

16. The system of claim 15, further comprising:
a memory for storing a pre-balancing table used for determining said pre-balancing time periods.

17. A method for balancing a plurality of battery cells, said method comprising:
sampling a plurality of discharging cell voltages of said battery cells at a predetermined time during a discharging state of said battery cells;
processing said discharging cell voltages according to voltage levels of said discharging cell voltages;
sampling a plurality of charging cell voltages of said battery cells during a charging state of said battery cells;
processing said charging cell voltages according to voltage levels of said charging cell voltages; and
providing control commands to control said battery cells to achieve a balance according to said processed charging cell voltages and discharging cell voltages.

18. The method of claim 17, wherein said predetermined time corresponds to end of said discharging state.

19. The method of claim 17, further comprising:
identifying an unbalanced battery cell based upon said charging cell voltages and said discharging cell voltages; and
performing a balancing operation on said unbalanced battery cell.

20. The method of claim 17, further comprising:
determining pre-balancing time periods for said battery cells based upon said discharging cell voltages; and
performing a pre-balancing operation on said battery cells during said pre-balancing time periods when said charging state is initiated.
